(19) United States
(12) Patent Application Publication
(10) Pub. No.: US 2002/0164181 A1
(43) Pub. Date: Nov. 7, 2002

(54) System, method and computer program product for generating a desirable image density using a plurality of image layers

(76) Inventors: Kenneth O. Parker, Mobile, AL (US); Robert C. Ross JR., Mobile, AL (US)

Correspondence Address: VENABLE, BAETJER, HOWARD AND CIVILETTI, LLP, P.O. BOX 34385, WASHINGTON, DC, 20043-9998, US

(21) Appl. No.: 10/134,395

(22) Filed: Apr. 30, 2002

Related U.S. Application Data
(60) Provisional application No. 60/287,417, filed on May 1, 2001.

(51) Int. Cl. G03G 15/01

(52) U.S. Cl. 399/298; 399/302

(57) ABSTRACT

A system, method and computer program product is disclosed for printing one or more color separation images for screen printing, wherein each color separation image has a plurality of toner layers resulting in desirable density. A method for screen print film generation, comprises the steps of producing a plurality of separations using a software application program; and applying a plurality of toner layers using said plurality of separations. A system that provides screen print film generation comprises a printer wherein said printer is operative to apply a plurality of toner layers. A computer program product embodied on a computer readable media, said computer program product comprising program logic comprising: producing means for enabling a computer to produce a plurality of separations; and applying means for enabling the computer to apply a plurality of toner layers using said plurality of separations. A method for high density color image generation includes the steps of producing a color image using a software application program; and applying a plurality of toner layers. At least one toner layer of the plurality of toner layers may include substantially clear toner. All toner layers of the plurality of toner layers may include an equal fraction of a desired finished color, the sum of all the toner layers achieving the desired finished color.

### BACKGROUND OF THE INVENTION

1. Field of the Invention

The present invention relates generally to printing systems, and more particularly to color printing systems.

2. Related Art

Screenprinting is a method of printing or transferring a graphic image onto some form of media. Screenprinting has also been referred to as serigraphy, creating a silk screen, and screen process printing. Media for receiving a screenprint can include, e.g., clothing or a canvas for art.

Since ancient times it has been known that a design image could be produced numerous times on media by stretching woven silk on a frame made of wood or later metal, attaching a stencil image of the design to the bottom of the silk with glue, and forcing ink through an opening in the stencil image.

The screenprinting process remains largely the same today. A design is divided into separate color images, a stencil carrying one of the images is applied to a frame having a mesh, ink and a squeegee are used, and a press system can place the reproduced image on the media.

The screen printing process can include various color separated, positive, emulsion-up films. Screens can be made of a fine mesh cloth stretched tightly over a metal frame and glued into place. A thin layer of light-sensitive emulsion can be applied to each screen. The film can be placed on top of an emulsion-coated screen and exposed to a bright light. The light can react with the emulsion, hardening it into the screen. The excess emulsion can then be washed away. A separate screen can be created for each color. A squeegee can press the appropriately colored ink through the screen. The media can pass underneath an ultraviolet light to cure the ink before the next color is applied.

Using the conventional screenprinting process, an original screenprint job can be designed using graphics publishing application software programs on a computer system. Such programs include, e.g., CORELDRAW® available from Corel Corporation of Ottawa, Ontario Canada, and ADOBE® ILLUSTRATOR® available from Adobe Systems Incorporated of San Jose, Calif. U.S.A.

The screenprint job can then be proofed on a color printer such as, e.g. a color laser printer such as, e.g., XANTE's Colour Laser™ available from XANTE of Mobile, Ala. U.S.A., or an inkjet printing device such as, e.g., those available from Lexmark International of Lexington, Conn. Once the screenprint job is approved from the color proof, the screenprinter can generate various film positive images on, e.g., opaque plastic material for each screen used in the printing of the final material.

The process of generating film positive images on the opaque plastic material can include directing the graphics publishing software application to produce color separations. Production of color separations involves producing a black and white image of each color separately to use as masters for the screen job. The film positive images can then be used by placing the film on a new piece of silkscreen mesh material.

UV light can be applied to the film and screen. Areas where the UV hits the screen can harden the emulsion on the screen. After about a minute of UV exposure the screen can be removed and the material that did not harden can be washed away. Being that the positive area of the film blocks the UV light and the opaque material allows the UV to penetrate, the screen produces a negative of the final imaged image to be transferred to the media such as, e.g., a t-shirt, mug, canvas, or other material

The film can be generated in various ways. A first way to generate a film uses a camera to shoot the image, and the film can be developed as a film master.

Another way to generate a film uses a conventional monochrome, black toner on white paper, laser printer to generate film output and then a liquid can be applied to the film that can increase the density of the black image of the film. Unfortunately, laser printers using toner typically do not deliver a dense enough black toner layer to filly block the UV light necessary to produce a usable film. A conventional solution has been to use a chemical agent that dissolves the toner slightly to increase density. However, this solution can still have the potential of not fully blocking UV light. Also, it is possible that the resulting toner layer may be uneven.

What is needed then is an improved method of generating a film that overcomes the shortcomings of conventional solutions.

### SUMMARY OF THE INVENTION

In an exemplary embodiment of the present invention a system, method and computer program product for generating a film that has a desirable image density for screen print processing is disclosed.

A method of generating a screenprint film according to the present invention is to use a printer to generate a multiple layer output having a desired density. In an exemplary embodiment, a color laser printer can be used to apply multiple toner layers.

According to an exemplary embodiment of the present invention, a color laser printer can be directed to produce color separations from a graphics software application program by producing black and white output separations for each color used in the silkscreen job, where the color separations are printed with a plurality of layers of toner on top of each other so as to obviate the conventional need for applying a chemical agent.

According to an exemplary embodiment of the present invention, the separate black and white output separations can be used without the need for application of a chemical agent by adding one or more additional toner layers to an existing toner image.

In an exemplary embodiment, a color laser printer can have, e.g., four colors of toner installed, such as, e.g., Cyan, Magenta, Yellow, and Black. The color laser printer, in an exemplary embodiment, can determine that a color separation job is printing. The determination step can be accomplished, e.g., by identifying, or by being directed by user or application notification that a color separation is being printed. When the color laser printer determines that a color separation job is printing, the color laser can duplicate the black plane to a second plane of any of the colors installed in the printer. The duplication of the black plane can lay down a second layer of toner in the exact spot as the first black layer, dramatically increasing the density of the image. Each new layer can be stacked on the previous layer. The process of laying down duplicate layers of toner can be expanded to include laying down more layers to further increase the density of the image. Thus, the present invention is directed to a method of performing multiple toner density imaging color separations.

In another exemplary embodiment, an ink jet printer can be used to apply multiple layers of ink reach a desired density for use in generating a color image separation.

In another exemplary embodiment, a conventional black and white laser printer can be used to apply more than one layer of toner onto an image.

In yet another exemplary embodiment, the present invention can be used to generate other film positive or negative outputs such as, e.g., offset printing.

In yet another exemplary embodiment, the present invention can be used to generate color or black and white output with increased density by adding multiple planes of toner of the same colors, in example nine passes, cyan, cyan, yellow, yellow, magenta, magenta, black, black, black passes, in order to increase the amount of toner in the image which can be used in applications such as heat transfer where increased toner density is necessary in order to bond to the desired substrate such as t-shirts, mugs, canvas, or other material. Of course, the toner used for any of the planes of toner is not limited to being cyan, magenta, yellow, or black, but can be any color at all or may lack color. The process of laying down duplicate layers of toner can be expanded to include laying down more layers to further increase the density of the image while still providing the desired finished color. The layers can be stacked atop one another. For example, one could print multiple layers, each layer having a fractional portion of the desired finished color (e.g., one third of the desired finished color could be printed in three passes to achieve the desired finished color).

The above and other exemplary embodiments of the invention are accomplished by the invention by the provision of a method for screen print film generation, including the steps of producing a plurality of separations using a software application program; and applying a plurality of toner layers using the plurality of separations. The toner layers may be applied by a color laser printer, a laser printer, an ink jet printer, or another type of printer. The separations may be color separations or black and white separations. The toner layers may be of any color, including, for example, cyan magenta, yellow, or black. Each toner layer may be a different color or two or more layers may be the same color. The method may be used to perform a silk screen job, for example. The software application program may include a graphical editing software application program, a word processing application program, a multimedia editing program, or operating systems.

Further exemplary embodiments of the invention may be accomplished by the provision of a system that provides screen print film generation. The system may include a printer which is operative to apply a plurality of toner layers. Again, this printer may be a color laser printer, a laser printer, an ink jet printer, or another type of printer. Each toner layer may be a different color or two or more layers may be the same color.

Another embodiment of the invention is accomplished by the invention by the provision of a method for high density color image generation including producing a color image using a software application program; and applying a plurality of toner layers. The number of toner layers may be an unlimited number of toner layers. The method could be used to perform a heat transfer job, for example. The toner layers may be stacked instead of intermixed with another toner layer. One possible advantage of stacking instead of intermixing could be in order to preserve the color of the image. All toner layers may be a similar color.

At least one toner layer may be substantially clear toner. It is to be appreciated that all toner layers of the plurality of toner layers can include an equal fraction of a desired finished color, the sum of all the toner layers achieving the desired finished color.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of an exemplary basic structure of a print system for performing a method of laying multiple layers of toner according to the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

### Overview

A method of generating a screenprint film according to the present invention is to use a printer to generate a multiple layer output having a desired density. In an exemplary embodiment, a color laser printer can be used to apply multiple toner layers.

According to an exemplary embodiment of the present invention, a color laser printer can be directed to produce color separations from a graphics software application program by producing black and white output separations for each color used in the silkscreen job, where the color separations are printed with a plurality of layers of toner so as to obviate the conventional need for applying a chemical agent.

According to an exemplary embodiment of the present invention, the separate black and white output separations can be used without the need for application of a chemical agent by adding one or more additional toner layers to an existing toner image.

In an exemplary embodiment, a color laser printer can have, e.g., four colors of toner installed, such as, e.g., Cyan, Magenta, Yellow, and Black. As would be apparent to those skilled in the relevant art, the present invention is equally applicable to color printers having more or less than four colors of toner. The color laser printer, in an exemplary embodiment, can determine that a color separation job is printing. The determination step can be accomplished, e.g., by identifying, or by being directed by user or application notification that a color separation is being printed. When the color laser printer determines that a color separation job is printing, the color laser can duplicate the black plane to any other color plane including black itself. The duplication of the black plane can lay down a second layer of toner in the exact spot as the first black layer, dramatically increasing the density of the image. The process of laying down duplicate layers of toner can be expanded to include laying down more layers to further increase the density of the image. Thus, the present invention is directed to a method of performing multiple toner density imaging color separations. For example, one could print multiple layers, each layer having a fractional portion of the desired finished color (e.g., one third of the desired finished color could be printed in three passes to achieve the desired finished color).

In another exemplary embodiment, an ink jet printer can be used to apply multiple layers of ink reach a desired density for use in generating a color image separation.

In another exemplary embodiment, a conventional black and white laser printer can be used to apply more than one layer of toner onto an image.

In yet another exemplary embodiment, the present invention can be used to generate other film positive or negative outputs such as, e.g., offset printing.

In yet another exemplary embodiment, the present invention can be used to generate increased toner density for heat transfer masters.

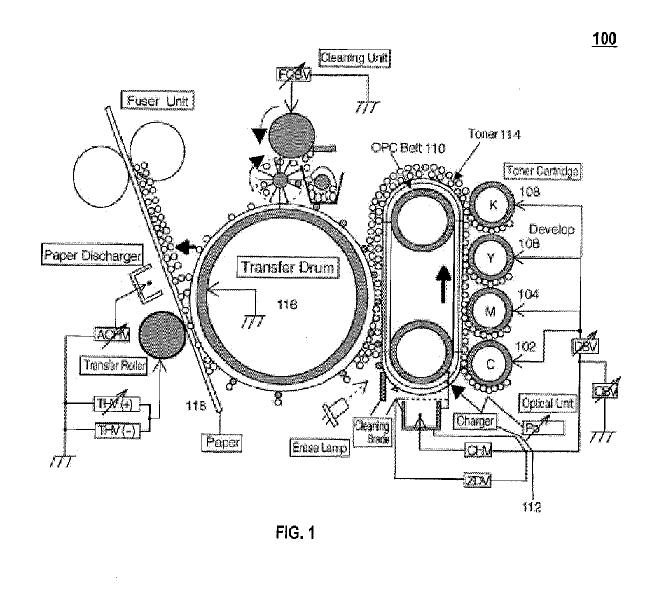

FIG. 1 depicts an exemplary embodiment of a basic structure of a printing system 100. The printing system 100 in an exemplary embodiment, is a color laser printer. The exemplary color laser printer is illustrated including, e.g., Cyan 102, Magenta 104, Yellow 106 and Black 108 toner cartridges. When producing a color print job using printing system 100, each color is separated by imaging software. The imaging software can in one exemplary embodiment be inside the printer. In another exemplary embodiment, the imaging software can be in an application that is running on a computer system (not shown) that can be coupled to the printing system 100.

When printing, each color plane can be applied separately to an organic photoconductive (OPC) belt 110 using a laser source 112 to image onto a light sensitive surface of the OPC belt 110. The color plane for a given color separation that is currently imaging to the OPC belt 110, can have the toner cartridge 102-108 reservoir of the color plane open at the time of imaging and all other cartridges 102-108 for other colors can be closed. Each time a plane is imaged the toner 114 on the belt can then be transferred to an intermediate transfer drum 116. The photo-sensitive intermediate drum can then cleared and another color from other cartridges 102-108 can be applied and transferred to the transfer drum 116. Once all the colors necessary have been moved to the transfer drum 116, the complete image can then be transferred to the desired media 118 such as, e.g., paper (as shown) or film.

According to an exemplary embodiment of the present invention, the black plane can be duplicated by any color, any number of times in the exact same areas in order to increase the opacity of the image. By placing a plurality of toner layers on the media 118, a desired density of image having desirable opacity for screen printing or other positive or negative film output can result.

It is important to note that although the exemplary embodiment relates to a color laser printer embodiment, the present invention is not limited to use with laser devices, or color devices. In another exemplary embodiment, an inkjet printer can also be used to apply a plurality of layers of ink to obtain an image with a desirable opacity characteristic.

In another exemplary embodiment, a black toner laser printer can apply several layers of toner to obtain a desirable toner density with a desirable opacity characteristic. In an exemplary embodiment, a software application program can be provided to prompt the user to reinsert a printed image to print one or more additional layers of an image over the existing printed image.

In yet another exemplary embodiment, the present invention can be applied to other positive or negative film output applications such as, e.g., offset printing.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for screen print film generation, comprising the steps of:
(a) producing a plurality of separations using a software application program; and
(b) applying a plurality of toner layers using said plurality of separations.

2. The method according to claim 1, wherein said step (b) is performed by at least one of: a color laser printer, a laser printer, an ink jet printer, and a printer.

3. The method according to claim 1, wherein said step (b) is performed by a color laser printer.

4. The method according to claim 1, wherein at least one separation of said plurality of separations comprises a color separation.

5. The method according to claim 1, wherein each separation of said plurality of separations comprises a black and white separation.

6. The method according to claim 1, wherein the method is used to perform a silk screen job.

7. The method according to claim 1, wherein said step (b) comprises:
applying at least one of: a cyan toner layer, a magenta toner layer, a yellow toner layer, and a black toner layer.

8. The method according to claim 1, wherein all toner layers of said plurality of toner layers comprise a similar color.

9. The method according to claim 1, wherein a first toner layer of said plurality of toner layers comprises a different color than a second toner layer of said plurality of toner layers.

10. The method according to claim 1, wherein said software application program comprises at least one of: a graphical editing software application program, a word processing application program, a multimedia editing program, and operating systems.

11. A system that provides screen print film generation comprising:
a printer wherein said printer is operative to apply a plurality of toner layers.

12. The system according to claim 11, wherein said printer is at least one of: a color laser printer, a laser printer, and an ink jet printer.

13. The system according to claim 11, wherein said printer is a color laser printer.

14. The system according to claim 11, wherein all toner layers of said plurality of toner layers comprise a similar color.

15. A system for providing screen print film generation comprising:
separation producing means for producing a plurality of separations; and
applying means for applying a plurality of toner layers using said plurality of separations.

16. A computer program product embodied on a computer readable media, said computer program product comprising program logic comprising:
producing means for enabling a computer to produce a plurality of separations; and
applying means for enabling the computer to apply a plurality of toner layers using said plurality of separations.

17. A method for high density color image generation comprising the steps of:
(a) producing a color image using a software application program; and
(b) applying a plurality of toner layers.

18. The method according to claim 17, wherein the plurality of toner layers comprises an unlimited number of toner layers.

19. The method according to claim 17, wherein the method is used to perform a heat transfer job.

20. The method according to claim 17, wherein a toner layer of said plurality of toner layers is stacked instead of intermixed with another toner layer of said plurality of toner layers.

21. The method according to claim 20, wherein said toner layer of said plurality of toner layers is stacked on said another toner layer in order to preserve the color of the image.

22. The method according to claim 17, wherein all toner layers of said plurality of toner layers comprise a similar color.

23. The method according to claim 17, wherein at least one toner layer of said plurality of toner layers comprises substantially clear toner.

24. The method according to claim 17, wherein all toner layers of said plurality of toner layers comprise an equal fraction of a desired finished color, the sum of said all toner layers achieving said desired finished color.
